(19) United States
(12) Patent Application Publication
(10) Pub. No.: US 2026/0188022 A1
(43) Pub. Date: Jul. 2, 2026

(54) DEVICE AND METHOD WITH ROAD OBJECT RECOGNITION

(71) Applicant: SAMSUNG ELECTRONICS CO., LTD., Suwon-si (KR)

(72) Inventors: Moonsub BYEON, Suwon-si (KR); Hongje SEONG, Suwon-si (KR); Junho CHO, Suwon-si (KR); Jiyeoup JEONG, Suwon-si (KR); Jiwon LEE, Suwon-si (KR); Ui Kun KWON, Suwon-si (KR); Dae Ung JO, Suwon-si (KR)

(73) Assignee: SAMSUNG ELECTRONICS CO., LTD., Suwon-si (KR)

(21) Appl. No.: 19/312,552

(22) Filed: Aug. 28, 2025

(30) Foreign Application Priority Data
Dec. 27, 2024 (KR) 10-2024-0198237

(51) Int. Cl. G06V 20/58; G06V 10/40; G06V 10/764; G06V 20/62; G06V 30/18; G06V 30/19; G08G 1/04

(52) U.S. Cl. CPC G06V 20/582; G06V 10/40; G06V 10/764; G06V 20/62; G06V 30/18; G06V 30/19173; G08G 1/04

(57) ABSTRACT

A device and method for road object recognition are provided. The device includes one or more processors and a memory storing instructions, in which the instructions, when executed by the one or more processors, cause the electronic device to determine a feature of an image captured from a vehicle, determine whether objects included in the image correspond to traffic signs, based on the determined feature, and, in response to determining that the objects correspond to the traffic signs, determine whether the objects correspond to one of detailed types of the traffic signs.

### CROSS-REFERENCE TO RELATED APPLICATIONS

This application claims the benefit under 35 USC § 119(a) of Korean Patent Application No. 10-2024-0198237, filed on Dec. 27, 2024, in the Korean Intellectual Property Office, the entire disclosure of which is incorporated herein by reference for all purposes.

### BACKGROUND

### 1. Field

The following description relates to a device and method with road object recognition.

### 2. Description of Related Art

With the recent advancements in the automobile industry, various advanced technologies are being applied to automobiles to improve driver convenience and vehicle safety. In particular, technologies that recognize objects from a forward image of a vehicle, captured by a camera that is mounted in the vehicle, are being implemented. To utilize technologies that classify and recognize objects in a vehicle that is travelling at a relatively high speed in various environments, a fast object recognition speed and a high object recognition rate may be desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an electronic device includes one or more processors; and a memory storing instructions, wherein the instructions, when executed by the one or more processors, cause the electronic device to: determine a feature of an image captured from a vehicle; determine, based on the determined feature, whether objects comprised in the image correspond to traffic signs; and determine, in response to determining that the objects correspond to the traffic signs, whether the objects correspond to one of detailed types of the traffic signs.

The instructions, when executed by the one or more processors, may cause the electronic device to: determine, based on the feature, first probabilities that the objects correspond to each of predetermined types of the objects; and determine whether the objects correspond to the traffic signs based on the determined first probabilities.

The instructions, when executed by the one or more processors, may cause the electronic device to: determine, based on the feature, second probabilities that the objects correspond to each of the detailed types of the traffic signs, in response to determining that the objects correspond to the traffic signs; and determine, based on the determined second probabilities, which of the detailed types of the traffic signs the objects correspond to.

The detailed types of the traffic signs may include at least one of a speed sign, a character sign, and a guidance sign.

The instructions, when executed by the one or more processors, may cause the electronic device to: determine traffic information indicated by the objects based on the detailed types of the traffic signs to which the objects correspond; and control the vehicle based on the determined traffic information.

The instructions, when executed by the one or more processors, may cause the electronic device to detect a speed limit written on the objects based on the feature, in response to determining that the objects correspond to a speed sign among the detailed types of the traffic signs.

The instructions, when executed by the one or more processors, may cause the electronic device to detect a character written on the objects based on the feature, in response to determining that the objects correspond to a character sign among the detailed types of the traffic signs.

The instructions, when executed by the one or more processors, may cause the electronic device to: determine, based on the feature, which of intermediate detailed types of the traffic signs the objects correspond to, in response to determining that the objects correspond to the traffic signs; and repeatedly perform, by a predetermined number of layers, the determination of which of the intermediate detailed types of the traffic signs the objects correspond to, based on an intermediate detailed type of traffic sign to which the objects correspond.

The instructions, when executed by the one or more processors, may cause the electronic device to determine, based on the feature, the intermediate detailed types of the traffic signs and the predetermined number of the layers.

The instructions, when executed by the one or more processors, may cause the electronic device to: determine whether the objects correspond to traffic lights, based on a determination that the objects do not correspond to the traffic signs; and determine whether the objects correspond to one of detailed types of the traffic lights, in response to determining that the objects correspond to the traffic lights.

The instructions, when executed by the one or more processors, may cause the electronic device to determine which of other types of the objects the objects comprised in the image correspond to, in response to determining that the objects do not correspond to the traffic signs.

In a general aspect, an electronic device includes one or more processors; and a memory storing instructions, wherein the instructions, when executed by the one or more processors, cause the electronic device to: determine a feature of an image captured from a vehicle; and determine, based on the determined feature, whether objects comprised in the image correspond to traffic lights; and determine, in response to determining that the objects correspond to the traffic lights, whether the objects correspond to one of detailed types of the traffic lights.

The instructions, when executed by the one or more processors, cause the electronic device to: determine, based on the feature, second probabilities that the objects correspond to each of the detailed types of the traffic lights, in response to determining that the objects correspond to the traffic lights; and determine, based on the determined second probabilities, which of the detailed types of the traffic lights the objects correspond to.

The detailed types of the traffic lights may be determined according to a number of signals of the traffic lights and a signal type of the traffic lights.

The instructions, when executed by the one or more processors, may cause the electronic device to: determine signal information indicated by the objects based on the detailed types of the traffic lights to which the objects correspond; and control the vehicle based on the determined signal information.

The instructions, when executed by the one or more processors, may cause the electronic device to: determine, based on the feature, which of intermediate detailed types of the traffic lights the objects correspond to, in response to determining that the objects correspond to the traffic lights; and repeatedly perform, by a predetermined number of layers, the determination of which of the intermediate detailed types of the traffic lights the objects correspond to, based on an intermediate detailed type of the traffic lights to which the objects correspond.

A method includes determining a feature of an image captured from a vehicle; determining, based on the determined feature, whether objects comprised in the image correspond to traffic signs; and determining, in response to determining that the objects correspond to the traffic signs, whether the objects correspond to one of detailed types of the traffic signs.

The determining of whether the objects correspond to the traffic signs may include determining, based on the feature, first probabilities that the objects correspond to each of predetermined types of the objects; and determining whether the objects correspond to the traffic signs based on the first probabilities.

The determining of whether the objects correspond to one of the detailed types of the traffic signs may include determining, based on the feature, second probabilities that the objects correspond to each of the detailed types of the traffic signs, in response to determining that the objects correspond to the traffic signs; and determining, based on the determined second probabilities, which of the detailed types of the traffic signs the objects correspond to.

The method may further include determining traffic information indicated by the objects based on the detailed types of the traffic signs to which the objects correspond; and controlling the vehicle based on the determined traffic information.

Other features and aspects will be apparent from the following detailed description, the drawings, and the claims.

### BRIEF DESCRIPTION OF DRAWINGS

FIG. 1 illustrates an example operation of an example electronic device, in accordance with one or more embodiments.

FIG. 2 illustrates an example process in which an example electronic device recognizes an object, in accordance with one or more embodiments.

FIG. 3 illustrates an example process in which an example electronic device classifies traffic signs, in accordance with one or more embodiments.

FIG. 4 illustrates an example of the type of object that a model trains, in accordance with one or more embodiments.

FIG. 5 illustrates an example of the detailed type of object that a model trains, in accordance with one or more embodiments.

FIG. 6 illustrates an example operation in which an example electronic device receives a feature, in accordance with one or more embodiments.

FIG. 7, FIG. 8, and FIG. 9 illustrate examples of a process in which an example electronic device classifies and recognizes traffic signs, in accordance with one or more embodiments.

FIG. 10, FIG. 11, and FIG. 12 illustrate examples of a process in which an example electronic device classifies and recognizes traffic lights, in accordance with one or more embodiments.

FIG. 13 illustrates an example process in which an example electronic device classifies and recognizes vehicles, in accordance with one or more embodiments.

FIG. 14 illustrates an example operation in which an example electronic device controls a vehicle through object recognition, in accordance with one or more embodiments.

FIG. 15 illustrates an example operating method of an example electronic device for a traffic sign, in accordance with one or more embodiments.

FIG. 16 illustrates an example operating method of an example electronic device for a traffic light, in accordance with one or more embodiments.

FIG. 17 illustrates an example electronic device, in accordance with one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

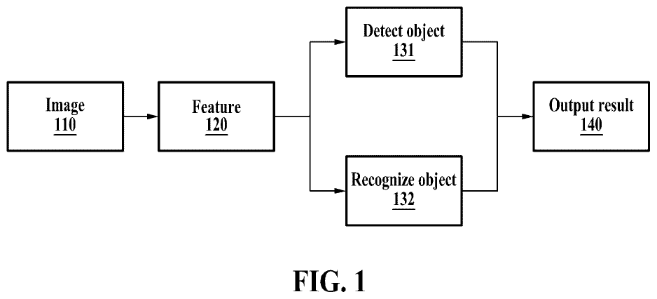

FIG. 1 illustrates an example operation of an electronic device, in accordance with one or more embodiments.

Referring to FIG. 1, the electronic device may determine a feature 120 from an image 110, detect an object based on the feature 120, recognize the object, and output a result of the recognition 140.

In an example, the electronic device may be a device that is mounted in a vehicle and detects and recognizes the object. In an example, the electronic device may include various computing devices, such as, but not limited to, a mobile phone, a smartphone, a tablet personal computer (PC), an e-book device, a laptop, a PC, a desktop, a workstation, or a server, various wearable devices, such as a smart watch, smart eyeglasses, a head-mounted display (HMD), or smart clothing, various home appliances, such as a smart speaker, a smart television (TV), or a smart refrigerator, and other devices, such as a smart vehicle, a smart kiosk, an Internet of Things (IoT) device, a walking assist device (WAD), a drone, or a robot, but examples are not limited thereto.

The image 110 may be acquired or captured from a camera mounted in the vehicle. The camera may acquire or capture the image 110 by capturing a predetermined direction (e.g., a forward direction) with respect to the vehicle. For example, the image 110 may be acquired by capturing a road ahead of the vehicle. The camera may capture an image 110 in a predetermined direction with respect to the vehicle, and the image 110 may be determined to be one of a plurality of frames included in the captured image. The electronic device may communicate with the camera in a wired or wireless manner, and may receive the image 110 captured by the camera. The electronic device may receive the image 110 at a predetermined time interval, or may receive the image 110 in response to the camera capturing the image 110.

The image 110 may include shapes of various objects on the road. For example, the objects may be, but are not limited thereto, vehicles, traffic signs, traffic lights, and people, as only examples. The electronic device may determine the feature 120 to classify and recognize the objects from the image 110 that is captured. In an example, the electronic device may determine the feature 120 from the image 110 based on a neural network. For ease of description, the feature 120 may also be referred to as an image feature herein.

In operation 131, the electronic device may detect objects included in the image 110 based on the feature 120. In operation 132, the electronic device may recognize, based on the feature 120, the objects (e.g., traffic signs and traffic lights) included in the image 110. In operation 131, the detecting of the objects may refer to determining whether the objects are included in the image 110, and where the objects are located in the image 110. In operation 132, the recognizing of the objects may refer to determining the types of objects and/or detailed types of objects and determining information (e.g., traffic information and signal information) included in the objects. For ease of description, the types of objects and detailed types of objects may be referred to as classes and detailed classes, respectively, herein. The electronic device may detect and recognize the objects by using an artificial intelligence (AI) model that pre-trains the types of objects and the detailed types of objects. The AI model may include an encoder that determines the feature 120.

In the operation 140, the electronic device may output the object detection result and the object recognition result to the image 110. For example, the electronic device may display a bounding box surrounding an object detected in the image 110 or may display a different color, shape, or type of bounding box depending on the recognition result of the object. In operation 140, the method in which the electronic device outputs the result to the image 110 may be different depending on examples.

The electronic device may perform both the object detection and object recognition based on the same feature 120, thereby reducing the amount of computation and computing power necessary for detection and recognition and increasing the recognition rate of the object. Additionally, by hierarchically recognizing the types and detailed types of objects, the electronic device may reduce data imbalance between the types or data imbalance between the detailed types occurring in the training stage of a model and may increase the recognition rate of the object. For example, to hierarchically recognize the types and detailed types of objects, the electronic device may train the model by taking the types and detailed types with a relatively small number of pieces of data as one type and detailed type.

The operations of determining the feature 120, detecting the object 131, recognizing the object 132, and outputting the object detection result and the object recognition result 140 may be performed by one or more processors.

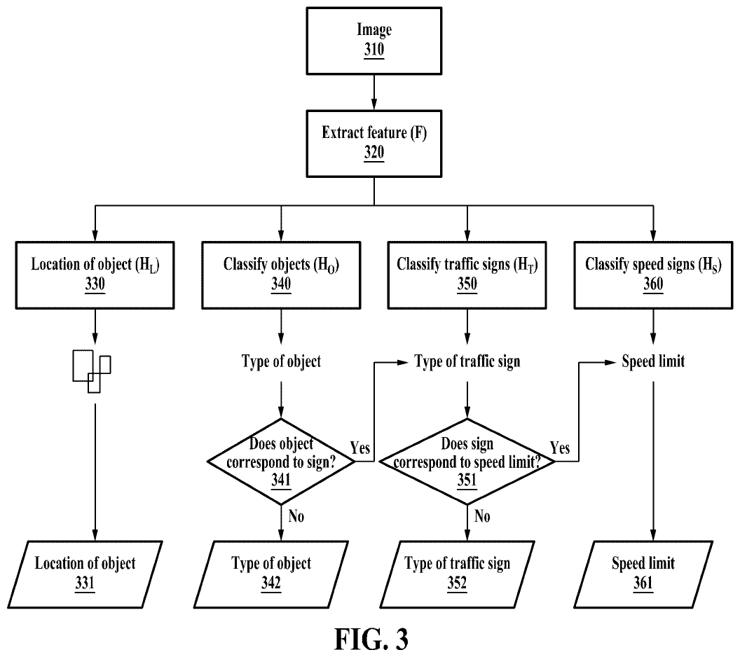

A process in which the electronic device detects and recognizes the objects is described in detail below with reference to FIGS. 3 to 14.

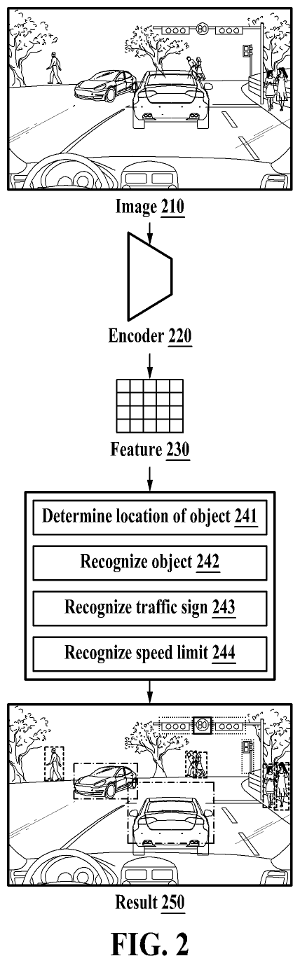

FIG. 2 illustrates an example process in which an example electronic device recognizes an object, in accordance with one or more embodiments.

Referring to FIG. 2, in operations 241 to 244, the electronic device may determine the location of the object from a feature 230, recognize the object, recognize a traffic sign, and recognize a speed limit. In FIG. 2, operations 241 to 244 are examples for description, and some of operations 241 to 244 may be omitted or another operation may be added thereto. The operations may be performed by one or more processors.

As non-limiting examples, the referenced one or more processors of the system may include a single processor or multiple processors to perform any combination or all method operations of the system described herein, and may refer to respective one or more processors configured to perform each of, as well as any combinations of, the component blocks and/or other operations illustrated or described herein, for performing the respective operations or other operations thereof. As a non-limiting example, each processor may include any one or any combination of any two or more of an application-specific integrated circuit (ASIC) chip, field-programmable gate arrays (FPGAs), or other programmable-logic device.

An encoder 220 may represent a module or device that determines the feature 230 from an image 210. The encoder 220 may be implemented as a module or device that is mounted inside the electronic device or as software or instructions executed by one or more processors of the electronic device. The encoder 220 may be implemented as a neural network such as a convolutional neural network (CNN), a deep CNN, a deep neural network (DNN), and a feedforward neural network (FNN). The neural network may include a plurality of nodes and a plurality of layers and may include connection weights that connect the plurality of nodes included in each of the plurality of layers to nodes included in another layer. For example, the neural network may include one or more convolutional layers, deconvolutional layers, normalization layers, and one or more activation functions. For example, when the size of data is represented as (height, width, channel), the encoder 220 may extract the feature 230 having a size of (128, 256, 128) from the image 210 having a size of (1024, 2048, 3).

In operation 241, the electronic device may determine the location of the object or objects of interest based on the feature 230. For example, the electronic device may display the locations of objects, which include traffic signs, as bounding boxes on the image 210. The electronic device may determine an x-coordinate-based center location (x), a y-coordinate-based center location (y), a top and bottom height (h₁, h₂), and a left and right width (w₁, w₂) of the object on the image 210. For example, the electronic device may determine coordinates (x, y, h₁, h₂, and w₁, w₂) representing the locations of the objects for each pixel of the feature 230 having a size of (128, 256, 128) and may output location information having a size of (128, 256, 6). The network structure for determining the locations of the objects may be arranged in the order of, for example, a convolutional layer, a ReLU activation layer, and a convolutional layer. For ease of description, the determination of the locations of the objects may also be referred to as localization, herein.

In operation 242, the electronic device may recognize a determined object (or object of interest) based on the feature 230. The electronic device may determine, based on the feature 230, first probabilities that the determined object corresponds to each of the predetermined types (e.g., vehicles, traffic signs, traffic lights, and people) of objects. Additionally, the electronic device may determine which of the predetermined types of objects the determined object corresponds to, based on the determined first probabilities. For example, for the predetermined N₀ types of objects, the electronic device may determine the first probabilities that each pixel of the feature 230 corresponds to each type of object and may output first probability information having a size of (128, 256, N₀). The electronic device may determine, based on the first probabilities, whether the determined object (or the object of interest) corresponds to a traffic sign among the predetermined types of objects. The network structure for recognizing the objects may be arranged in the order of, for example, a convolutional layer, a ReLU activation layer, and a convolutional layer, as only examples.

In operation 242, regardless of the location of the object being detected, the electronic device may determine, based on the feature 230, the first probabilities that each pixel of the feature 230 corresponds to each type of object. For example, the electronic device may determine the first probabilities that each pixel corresponds to each type of object by using a graphics processing unit (GPU).

In operation 243, the electronic device may recognize the traffic sign based on the feature 230. When it is determined that the determined object corresponds to the traffic sign, the electronic device may determine, based on the feature 230, second probabilities that the object corresponds to each of the detailed types (e.g., speed signs, character signs, and guidance signs) of traffic signs. Additionally, the electronic device may determine, based on the second probabilities, which of the detailed types of traffic signs the object of interest corresponds to. For example, for the predetermined N_{T} detailed types of traffic signs, the electronic device may determine the second probabilities that each pixel of the feature 230 corresponds to the detailed type of traffic sign, and may output second probability information having a size of (128, 256, N_{T}). The network structure for recognizing the traffic sign may be arranged in the order of, for example, a convolutional layer, a ReLU activation layer, and a convolutional layer.

Additionally, the electronic device may hierarchically classify the detailed types and hierarchically determine which detailed type the object of interest corresponds to. For example, when it is determined that the object of interest corresponds to the character sign among the traffic signs, the electronic device may further determine which detailed types (e.g., stop, yield, and caution) among the character signs the object corresponds to.

In operation 243, regardless of the determination that the object of interest corresponds to the traffic sign, the electronic device may determine, based on the feature 230, the second probabilities that the object corresponds to each of the detailed types of traffic signs. For example, the electronic device may determine the second probabilities that each pixel of the feature 230 corresponds to each of the detailed types of traffic signs, and when it is determined that the object corresponds to the traffic sign, the electronic device may then determine, based on the second probabilities, which detailed type the object corresponds to.

In operation 244, the electronic device may recognize the speed limit based on the feature 230. When it is determined that the object of interest corresponds to the speed sign among the traffic signs, the electronic device may determine, based on the feature 230, probabilities that the object corresponds to each of the detailed types (e.g., 5, 25, 30, 50, and 100) according to the speed of the speed sign. The electronic device may recognize the speed limit written on the object based on the probabilities. For example, for the predetermined N_{S} detailed types of speed signs, the electronic device may determine the probabilities that each pixel of the feature 230 corresponds to the detailed type of speed sign and may output probability information having a size of (128, 256, N_{S}). The network structure for recognizing the speed sign may be arranged in the order of, for example, a convolutional layer, a ReLU activation layer, and a convolutional layer, as only examples.

In operation 244, regardless of the determination that the object of interest corresponds to the speed sign, the electronic device may determine, based on the feature 230, the probabilities that the object of interest corresponds to each of the detailed types of speed signs. For example, the electronic device may determine the probabilities that each pixel of the feature 230 corresponds to each of the detailed types of speed signs, and when it is determined that the object of interest corresponds to the speed sign, the electronic device may then determine which detailed type the object of interest corresponds to, based on the probabilities.

FIG. 3 illustrates an example process in which an example electronic device classifies traffic signs.

FIG. 3 illustrates the operations in which the electronic device classifies the traffic signs. The operations may be performed sequentially but not necessarily. For example, the order of the operations may be changed and at least two of the operations may be performed in parallel.

In operation 310, the electronic device may acquire an image from a camera.

In operation 320, the electronic device may determine a feature F from the image.

In operation 330, the electronic device may determine locations of objects included in the image based on the determined feature F. The electronic device may determine the locations of the objects through an object location head H_{L} of the determined feature F.

In operation 331, the electronic device may output the determined location of the object onto the image. The electronic device may output the location of the object, regardless of the determined type, or detailed type, of object.

In operation 340, the electronic device may classify the objects based on the determined feature F. The electronic device may classify the types of objects by determining first probabilities that each pixel of the feature F corresponds to each of the predetermined types of objects. The electronic device may determine which type of object the object of interest corresponds to, based on the first probabilities of pixels corresponding to the locations of the objects. The electronic device may determine the type of object through an object classification head H_{O} of the determined feature F.

In operation 341, the electronic device may determine whether the object corresponds to the traffic sign.

In operation 342, the electronic device may output the type of object determined in operation 340 when it is determined that the object does not correspond to the traffic sign.

In operation 350, the electronic device may classify the traffic signs based on the determined feature F. The electronic device may classify the detailed types of traffic signs to which the object corresponds, by determining second probabilities that each pixel of the feature F corresponds to each of the predetermined detailed types. The electronic device may determine which detailed type of object the object of interest corresponds to, based on the second probabilities of pixels corresponding to the locations of the objects. The electronic device may determine the detailed types of traffic signs to which the object of interest corresponds through a traffic sign classification head H_{T} of the determined feature F.

In operation 351, the electronic device may determine whether the object corresponds to the speed sign among the traffic signs. The speed sign may be a sign indicating the speed limit on the road.

In operation 352, the electronic device may output the detailed type of traffic sign determined in operation 350 when it is determined that the object of interest does not correspond to the speed sign.

In operation 360, the electronic device may classify the speed signs based on the determined feature F. The electronic device may classify the detailed types of speed signs to which the object corresponds, by determining probabilities that each pixel of the feature F corresponds to each of the detailed types of speed signs. For example, the speed signs may be classified based on the written speed limit. The electronic device may determine which detailed type of object the object of interest corresponds to, based on the probabilities that pixels corresponding to the locations of the objects correspond to the detailed types of speed signs. The electronic device may determine the detailed types of speed signs to which the object corresponds to through a speed sign classification head H_{S} of the determined feature F.

In operation 361, the electronic device may output the detailed type of speed sign determined in operation 360. Additionally, the electronic device may output the speed limit corresponding to the determined detailed type of speed sign.

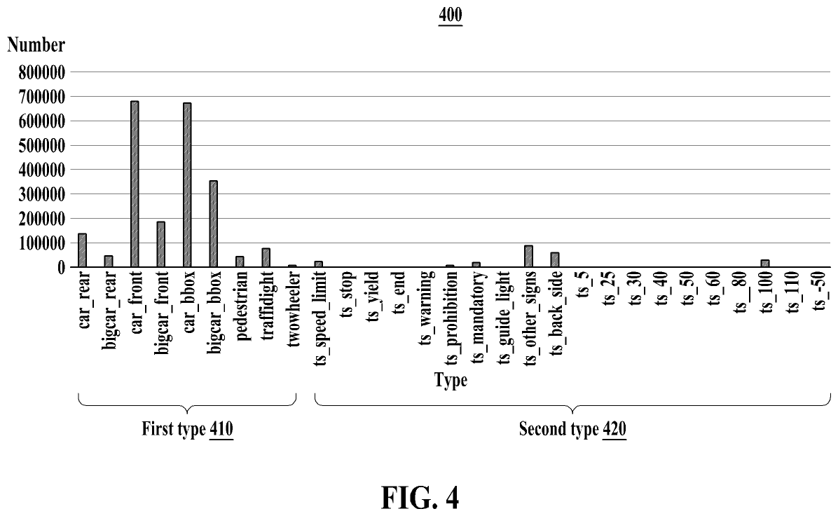

FIG. 4 illustrates an example of the type of object that a model trains.

FIG. 4 illustrates a distribution of training data 400 for a model trained to classify objects. The training data 400 and the types of objects illustrated in FIG. 4 are examples for description, and the examples are not limited thereto.

In the example of FIG. 4, the number of pieces of data acquired depending on the type of object may vary. The training data 400 may be divided into a first type 410 having a relatively large amount of data and a second type 420 having a relatively small amount of data. The model used by an electronic device may be trained by dividing the second type 420 of data, which has a relatively small number of pieces of training data, into one type. The first type 410 and the second type 420 may be determined differently depending on the training data 400.

For example, images obtained by capturing a road may include more data of a vehicle than that of a traffic sign. In this example, in the training data 400 of the model that trains the images, the first type 410 may represent the data of the vehicle and the second type 420 may represent the data of the traffic sign. The model used by the electronic device may be trained by dividing the detailed types of traffic signs into one type.

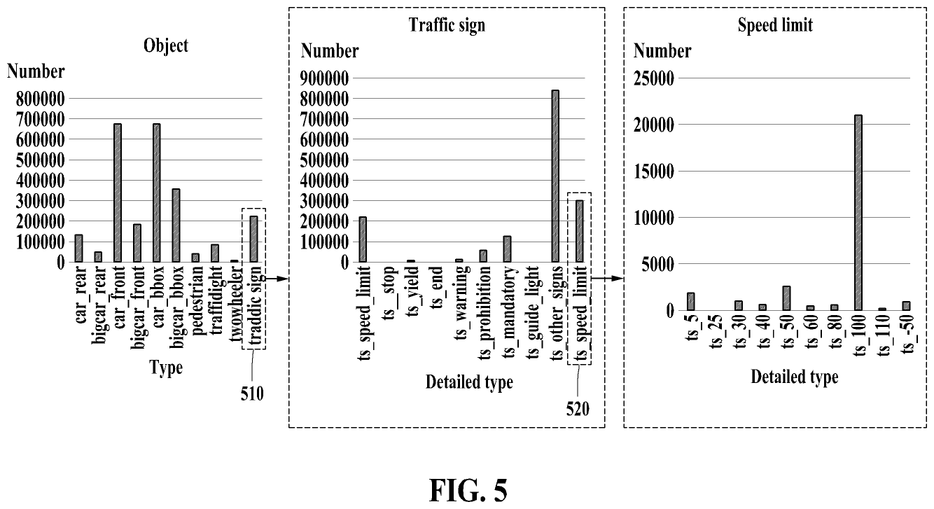

As the model is trained by dividing the data of the second type 420 into one type, class imbalance between the types may be reduced and the recognition rate of the second type 420 may increase. The electronic device may increase the recognition rate of the traffic sign by first classifying an example in which objects correspond to the traffic signs and an example in which an objects do not correspond to the traffic signs and then hierarchically classifying the detailed types of traffic signs. The hierarchical classification of the detailed types of traffic signs is described in detail below with reference to FIG. 5.

FIG. 5 illustrates an example of the detailed type of object that a model trains.

Referring to FIG. 5, the model may hierarchically classify objects by using the types and detailed types. Training data and types and detailed types of objects illustrated in FIG. 5 are examples for description, and examples are not limited thereto.

In the example of FIG. 5, the number of pieces of data acquired for each detailed type of data of a predetermined type 510 may be different. The model used by an electronic device may be trained by dividing pieces of data of a detailed type 520, which have a relatively small number of pieces of training data, into the detailed type 520. The data trained with one detailed type may be determined differently depending on the training data.

For example, among the traffic signs, the number of pieces of data of a speed sign may be less than the number of pieces of data of another traffic sign. The model used by the electronic device may be trained by dividing the pieces of data of the speed sign into the detailed type 520.

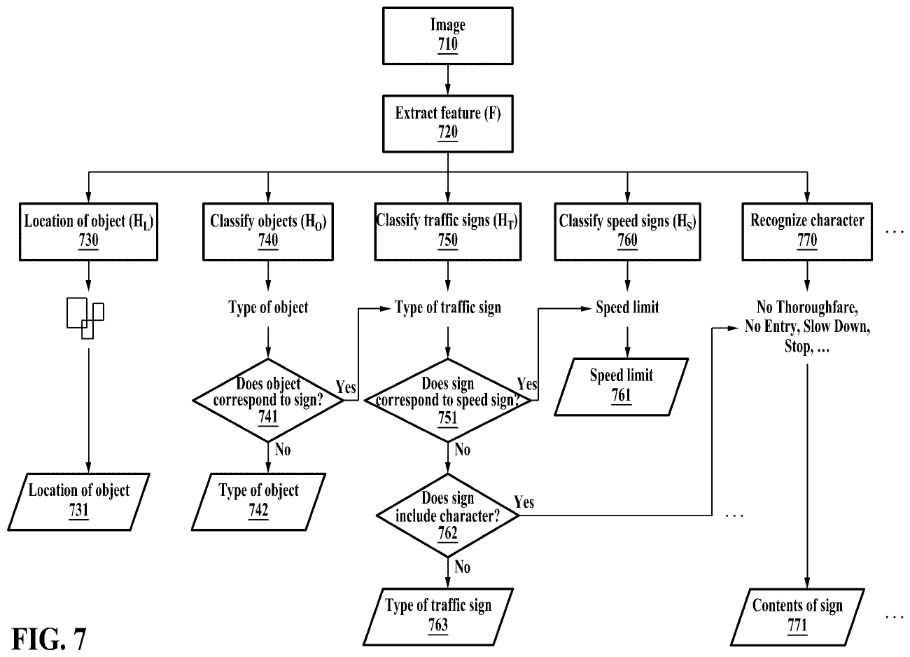

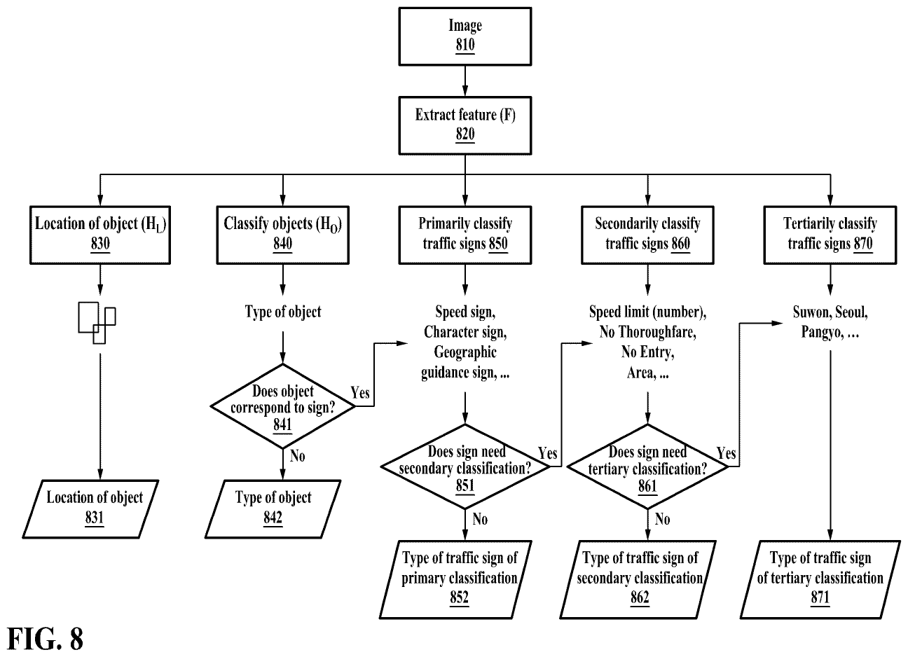

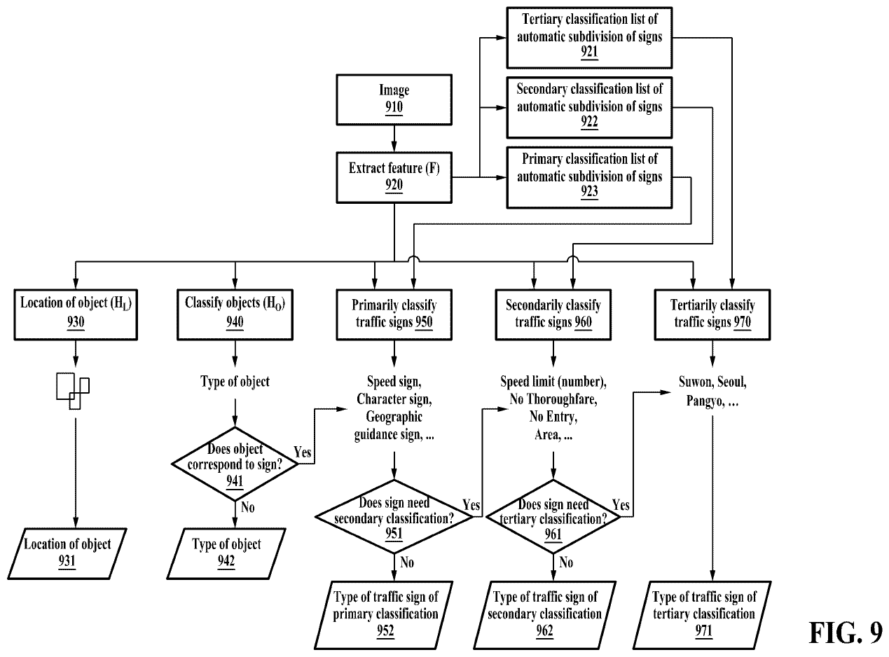

The electronic device may divide, by a predetermined number of layers, the detailed types of layers of pieces of data. For ease of description, the detailed types of layers for determining the detailed types of objects may be represented as intermediate detailed types. The electronic device may determine which type and detailed type the object corresponds to, based on the detailed types of layers. For example, when it is determined that the object corresponds to the traffic sign, the electronic device may determine which of the intermediate detailed types of traffic signs the object corresponds to. The electronic device may determine which intermediate detailed type the object corresponds to, by repeatedly performing, by a predetermined number of layers, the determination of which of the intermediate detailed types of traffic signs the object corresponds to, based on an intermediate detailed type to which the object corresponds. The process of determining the detailed type of object through the detailed types of layers is described in detail below with reference to FIGS. 7 and 8.

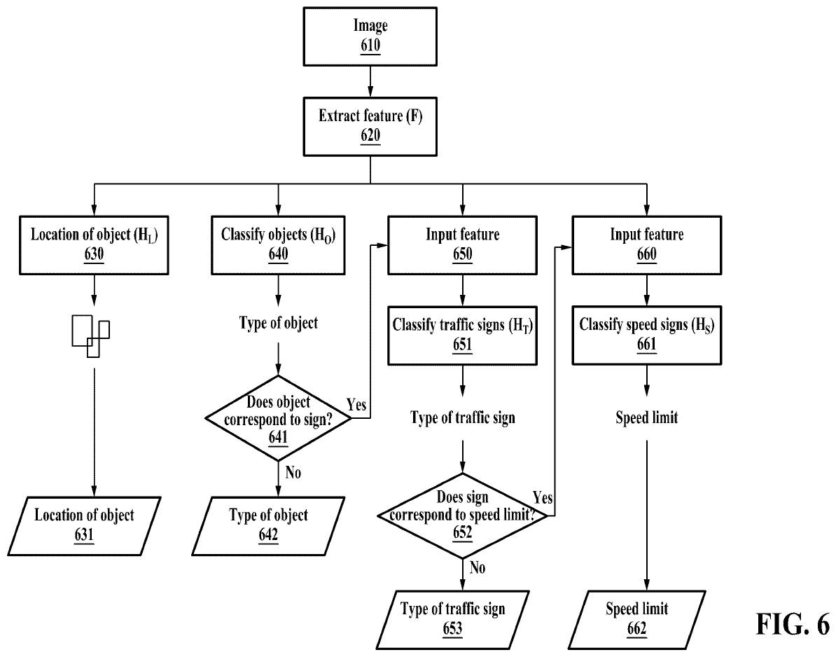

FIG. 6 illustrates an example of an operation in which an electronic device receives a feature.

Referring to FIG. 6, the electronic device may determine a detailed classification of objects by using the feature when the objects correspond to traffic signs. Operations 610, 620, 630, 631, 640, 641, 642, 651, 652, 653, 660, 661, and 662 of FIG. 6 are described in detail with reference to FIG. 3, so any redundant description is omitted.

In operation 650, the electronic device may receive the feature determined in operation 620 when it is determined that an object corresponds to a traffic sign.

In operation 651, the electronic device may classify the detailed types of traffic signs to which the object corresponds, by determining second probabilities that each pixel of the feature corresponds to each of the predetermined detailed types. Alternatively, the electronic device may determine the second probabilities that pixels corresponding to the object in the received feature correspond to the detailed types of traffic signs.

In operation 660, the electronic device may receive the feature determined in operation 620 when it is determined that the object corresponds to a speed sign among the traffic signs.

In operation 661, the electronic device may classify the detailed types of speed signs to which the object corresponds, by determining probabilities that each pixel of the feature corresponds to each of the detailed types of speed signs. Alternatively, the electronic device may determine the probabilities that pixels corresponding to the object in the received feature correspond to the detailed types of speed signs.

FIGS. 7 to 9 illustrate examples of a process in which an electronic device classifies and recognizes the traffic signs.

FIG. 7 illustrates an example of operations for the electronic device to recognize a traffic sign. Operations 710, 720, 730, 731, 740, 741, 742, 750, 751, 760, and 761 of FIG. 7 are described in detail with reference to FIG. 3, so any redundant description is omitted.

In operation 762, the electronic device may determine whether an object corresponds to a character sign when it is determined that the object does not correspond to the speed sign. The character sign may indicate a sign including characters (e.g., Korean or English).

In operation 751, the electronic device may determine whether the object corresponds to the character sign. In operation 762, the electronic device may determine whether the object corresponds to the speed sign when the object does not correspond to the character sign. In this example, in operation 760, the electronic device may determine which detailed classification among the character signs the object of interest corresponds to. In operation 761, the electronic device may output the corresponding detailed classification.

In operation 763, the electronic device may output the type of traffic sign determined in operation 750 when it is determined that the object does not correspond to the character sign.

In operation 770, the electronic device may recognize the character written on an image based on a determined feature. The electronic device may classify the detailed types of character signs to which the object corresponds, by determining probabilities that each pixel of the feature corresponds to each of the predetermined detailed types associated with the character. The electronic device may determine which detailed type the object corresponds to, based on the probabilities that pixels corresponding to the location of the object correspond to the detailed types. The contents of the character sign may include, but are not limited thereto, examples of “No Thoroughfare,” “No Entry,” “Slow Down,” and “Stop.”

In operation 771, the electronic device may output the character recognized for the object. For example, the electronic device may output the contents of the sign written on the object.

FIG. 8 illustrates an example of operations for the electronic device to classify the traffic signs through intermediate detailed classification. Operations 810, 820, 830, 831, 840, 841, and 842 of FIG. 8 are described in detail with reference to FIG. 3, so any redundant description is omitted.

The electronic device may hierarchically determine the detailed types of traffic signs to which an object corresponds through operation 850, operation 860, and operation 870. In the example of FIG. 8, the electronic device classifies the detailed types of traffic signs through three layers, but the examples are not limited thereto, and the number of layers may be one or more.

In operation 850, the electronic device may primarily classify the traffic signs based on a determined feature. The electronic device may determine a primary detailed type of traffic sign to which the object corresponds, by determining probabilities that each pixel of the feature corresponds to each of the predetermined primary detailed types. For example, the primary detailed type may represent a speed sign, a character sign, and a guidance sign.

In operation 851, the electronic device may determine whether secondary classification of the traffic signs is necessary based on the determined primary detailed types. Whether the secondary classification is necessary may be predetermined based on the primary detailed type.

In operation 852, the electronic device may output the primary detailed type of object when it is determined that the secondary classification is not necessary.

In operation 860, the electronic device may secondarily classify the traffic signs based on the determined feature. The electronic device may determine a secondary detailed type of traffic sign to which the object corresponds, by determining probabilities that each pixel of the feature corresponds to each of the predetermined secondary detailed types. For example, the secondary detailed type may represent a speed limit in the example of speed signs and represent “No Thoroughfare,” “No Entry,” and an area in the example of character signs.

In operation 861, the electronic device may determine whether tertiary classification of the traffic signs is necessary based on the determined secondary detailed types. Whether the tertiary classification is necessary may be predetermined based on the secondary detailed type.

In operation 862, the electronic device may output the secondary detailed type of object when it is determined that the tertiary classification is not necessary.

In operation 870, the electronic device may tertiarily classify the traffic signs based on the determined feature. The electronic device may determine a tertiary detailed type of traffic sign to which the object corresponds, by determining probabilities that each pixel of the feature corresponds to each of the predetermined tertiary detailed types. For example, the tertiary detailed type may represent a specific place name in the example in which the character sign represents an area.

In operation 871, the electronic device may output the tertiary detailed type of object.

FIG. 9 illustrates an example of operations for the electronic device to classify the traffic signs through intermediate detailed classification determined through a feature. Operations 910, 920, 930, 931, 940, 941, 942, 950, 951, 952, 960, 961, 962, 970, and 971 of FIG. 9 are described in detail with reference to FIGS. 3 and 8, so any redundant description is omitted.

The electronic device may determine, based on the feature, layers, intermediate detailed types, and detailed types for classifying the objects through operation 921, operation 922, and operation 923. For example, the electronic device may determine the layers, the intermediate detailed types, and the detailed types for classifying the objects by using a pre-trained model for the objects in an image. The electronic device may determine, based on the feature, classification lists representing the intermediate detailed types for each layer.

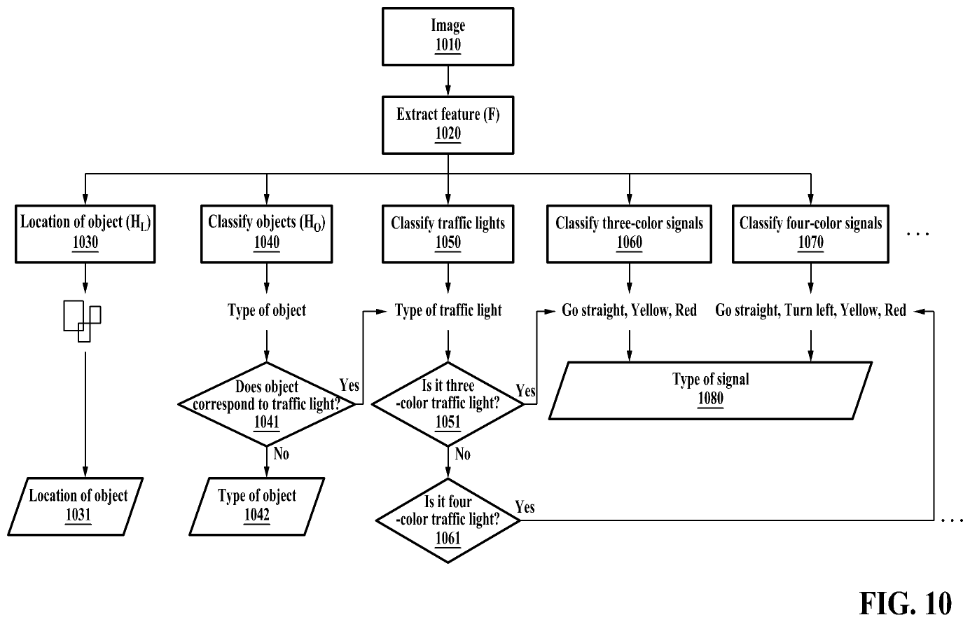

FIGS. 10 to 12 illustrate examples of a process in which an electronic device classifies and recognizes the traffic lights.

FIG. 10 illustrates an example of operations for the electronic device to recognize a traffic light. Operations 1010, 1020, 1030, 1031, 1040, and 1042 of FIG. 10 are described in detail with reference to FIG. 3, so any redundant description is omitted.

In operation 1041, the electronic device may determine whether an object corresponds to the traffic light.

In operation 1042, the electronic device may output the type of object determined in operation 1040 when it is determined that the object does not correspond to the traffic light.

In operation 1050, the electronic device may classify the traffic lights based on a determined feature. The electronic device may classify the detailed types of traffic lights to which the object corresponds, by determining second probabilities that each pixel of the feature corresponds to each of the predetermined detailed types. The electronic device may determine which detailed type of object the object corresponds to, based on the second probabilities of pixels corresponding to the location of the object.

In operation 1051, the electronic device may determine whether the object of interest corresponds to a three-color traffic light among the types of traffic lights. The three-color traffic light may represent a traffic light including three signals. The three-color traffic light is only an example, and traffic lights of any number of individual lights may be implemented.

In operation 1060, the electronic device may classify the signals of the three-color traffic light based on the determined feature. The electronic device may classify the detailed types of signals of the three-color traffic light to which the object corresponds, by determining probabilities that each pixel of the feature corresponds to each of the detailed types of signals of the three-color traffic light. For example, the three-color traffic light may be classified based on the types (e.g., go straight (green), yellow, and red) of included signals. The electronic device may determine which detailed type of signal the object corresponds to, based on the probabilities that pixels corresponding to the location of the object correspond to each of the detailed types of signals of the three-color traffic light.

In operation 1061, the electronic device may determine whether the object corresponds to a four-color traffic light when it is determined that the object does not correspond to the three-color traffic light. The four-color traffic light may represent a traffic light including four signals.

In operation 1070, the electronic device may classify the signals of the four-color traffic light based on the determined feature. The electronic device may classify the detailed types of signals of the four-color traffic light to which the object corresponds, by determining probabilities that each pixel of the feature corresponds to each of the detailed types of signals of the four-color traffic light. For example, the four-color traffic light may be classified based on the types (e.g., go straight (green), turn left, yellow, and red) of included signals. The electronic device may determine which detailed type of signal the object corresponds to, based on the probabilities that pixels corresponding to the location of the object correspond to each of the detailed types of signals of the four-color traffic light.

In operation 1080, the electronic device may output the determined detailed classification of the signals. For example, the electronic device may output a signal corresponding to the signal detailed classification.

The electronic device may perform additional classification other than operations 1060 and 1070 depending on the type of traffic light. For example, the electronic device may further classify the signals of a two-color traffic light based on the feature.

FIG. 11 illustrates an example of operations for classifying the traffic lights through intermediate detailed classification. Operations 1110, 1120, 1130, 1131, 1140, 1141, and 1142 of FIG. 11 are described in detail with reference to FIGS. 3 and 10, so any redundant description is omitted.

The electronic device may hierarchically determine the detailed types of traffic lights to which the object corresponds, through operation 1150, operation 1160, and operation 1170. In the example of FIG. 11, the electronic device classifies the detailed types of traffic lights through three layers, but examples are not limited thereto, and the number of layers may be one or more.

In operation 1150, the electronic device may primarily classify the traffic lights based on a determined feature. The electronic device may determine a primary detailed type of traffic light to which the object corresponds, by determining probabilities that each pixel of the feature corresponds to each of the predetermined primary detailed types. For example, the primary detailed type may include a three-color traffic light and a four-color traffic light.

In operation 1151, the electronic device may determine whether secondary classification of the traffic lights is necessary based on the determined primary detailed types. Whether the secondary classification is necessary may be predetermined based on the primary detailed type.

In operation 1152, the electronic device may output the primary detailed type of object when it is determined that the secondary classification is not necessary.

In operation 1160, the electronic device may secondarily classify the traffic lights based on the determined feature. The electronic device may determine a secondary detailed type of traffic light to which the object corresponds, by determining probabilities that each pixel of the feature corresponds to each of the predetermined secondary detailed types. For example, the secondary detailed type may include a pedestrian signal, a right turn-only signal, and a train track signal, as only examples.

In operation 1161, the electronic device may determine whether tertiary classification of the traffic lights is necessary based on the determined secondary detailed type. Whether the tertiary classification is necessary may be predetermined based on the secondary detailed type.

In operation 1162, the electronic device may output the secondary detailed type of object when it is determined that the tertiary classification is not necessary.

In operation 1170, the electronic device may tertiarily classify the traffic lights based on the determined feature. The electronic device may determine a tertiary detailed type of traffic light to which the object corresponds, by determining probabilities that each pixel of the feature corresponds to each of the predetermined tertiary detailed types. For example, the tertiary detailed type may represent traffic signals (e.g., go straight, turn left, yellow, and red) of the traffic light.

In operation 1171, the electronic device may output the tertiary detailed type of object.

FIG. 12 illustrates an example of operations for the electronic device to classify the traffic signs through intermediate detailed classification determined through a feature. Operations 1210, 1220, 1230, 1231, 1240, 1241, 1242, 1250, 1251, 1252, 1260, 1261, 1262, 1270, and 1271 of FIG. 12 are described in detail with reference to FIGS. 3 and 11, so any redundant description is omitted.

The electronic device may determine, based on the feature, layers, intermediate detailed types, and detailed types to classify the objects through operation 1221, operation 1222, and operation 1223. For example, the electronic device may determine the layers, the intermediate detailed types, and the detailed types to classify the objects by using a pre-trained model for the objects in an image. The electronic device may determine, based on the feature, classification lists representing the intermediate detailed types for each layer.

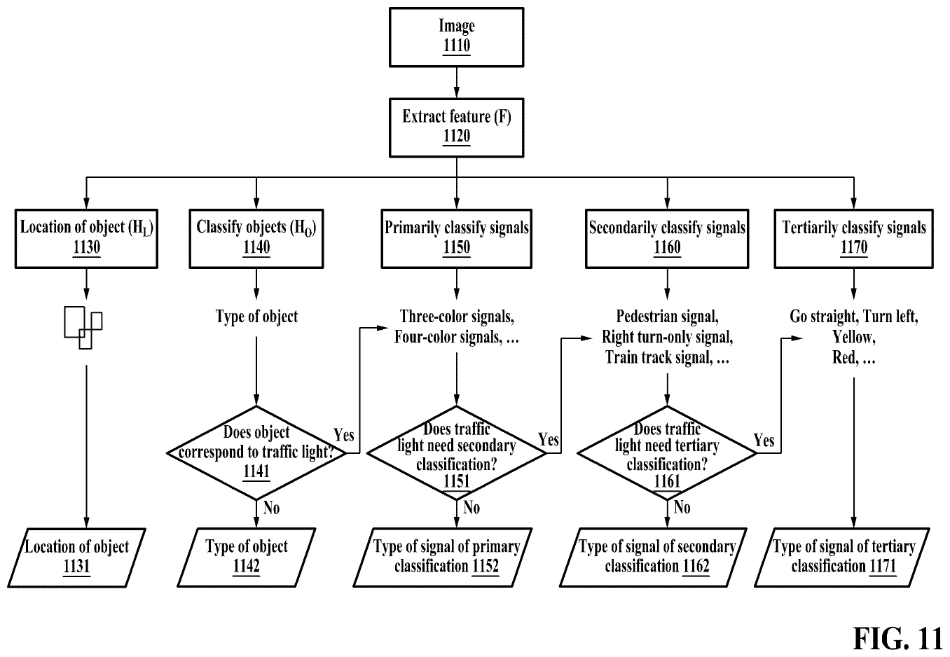

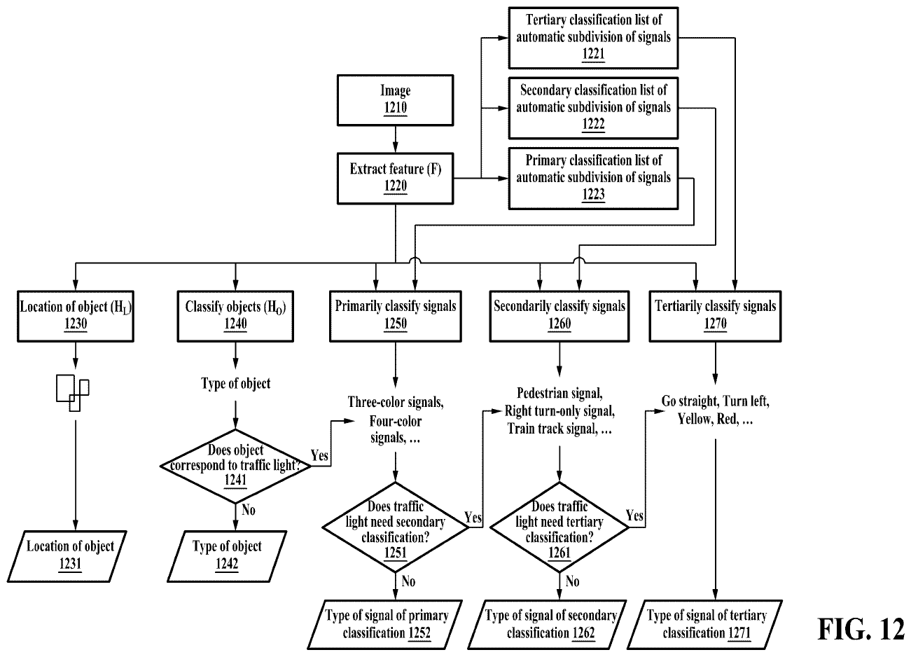

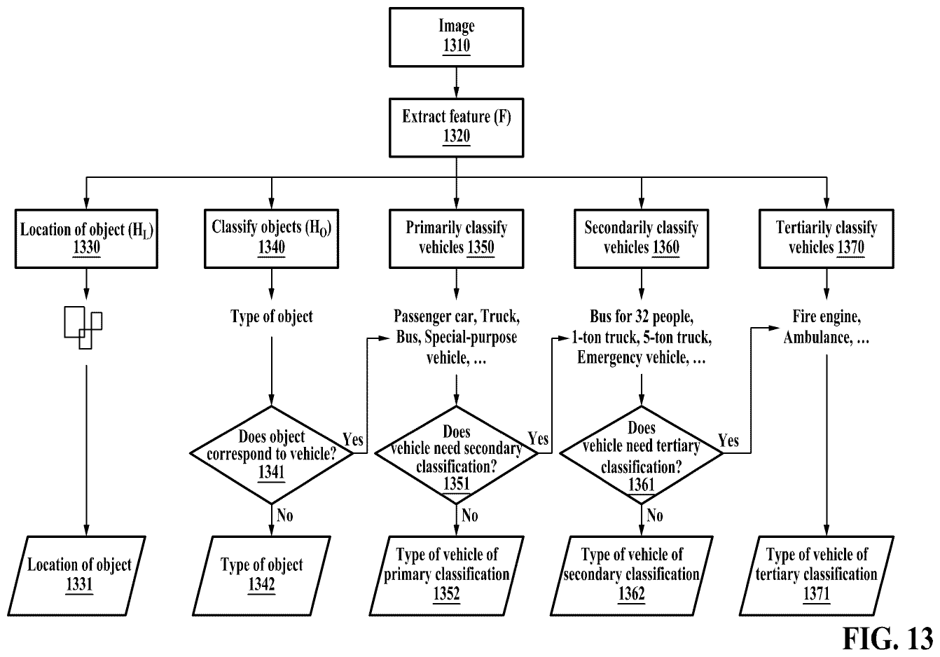

FIG. 13 illustrates an example process in which an electronic device classifies and recognizes the vehicles.

FIG. 13 illustrates an example of operations for an electronic device to classify and recognize vehicles. Operations 1310, 1320, 1330, 1331, and 1340 of FIG. 13 are described in detail with reference to FIG. 3, so any redundant description is omitted.

The electronic device may hierarchically determine the detailed types of vehicles to which the object corresponds, through operation 1350, operation 1360, and operation 1370. In the example of FIG. 13, the electronic device classifies the detailed types of vehicles through three layers, but examples are not limited thereto, and the number of layers may be one or more. Additionally, in the example of FIG. 13, only hierarchical recognition is shown when the object corresponds to the vehicle. However, the examples are not limited thereto, and the electronic device may perform hierarchical recognition in a manner similar to the operations of FIG. 13, even when the object corresponds to, for example, a person, an obstacle, a road, and a lane line.

In operation 1341, the electronic device may determine whether the object corresponds to the vehicle. The electronic device may determine whether the object corresponds to the vehicle when it is determined that the object does not correspond to a traffic sign and/or a traffic light.

In operation 1342, the electronic device may output the type of object determined in operation 1340 when it is determined that the object does not correspond to the vehicle.

In operation 1350, the electronic device may primarily classify the vehicles based on a determined feature. The electronic device may determine a primary detailed type of vehicle to which the object corresponds, by determining probabilities that each pixel of the feature corresponds to each of the predetermined primary detailed types. For example, the primary detailed type may include a passenger car, a truck, a bus, and a special-purpose vehicle, as only examples.

In operation 1351, the electronic device may determine whether secondary classification of the vehicles is necessary based on the determined primary detailed types. Whether the secondary classification is necessary may be predetermined based on the primary detailed type.

In operation 1352, the electronic device may output the primary detailed type of object when it is determined that the secondary classification is not necessary.

In operation 1360, the electronic device may secondarily classify the vehicles based on the determined feature. The electronic device may determine a secondary detailed type of vehicle to which the object corresponds, by determining probabilities that each pixel of the feature corresponds to each of the predetermined secondary detailed types. For example, the secondary detail type may include the number of people available for boarding a vehicle, the weight available for loading a truck, and the intended use of a vehicle.

In operation 1361, the electronic device may determine whether tertiary classification of the vehicles is necessary based on the determined secondary detailed types. Whether the tertiary classification is necessary may be predetermined based on the secondary detailed type.

In operation 1362, the electronic device may output the secondary detailed type of object when it is determined that the tertiary classification is not necessary.

In operation 1370, the electronic device may tertiarily classify the vehicles based on the determined feature. The electronic device may determine a tertiary detailed type of vehicle to which the object corresponds, by determining probabilities that each pixel of the feature corresponds to each of the predetermined tertiary detailed types. For example, the tertiary detailed type may represent a specific type and model of the vehicle.

In operation 1371, the electronic device may output the tertiary detail type of object.

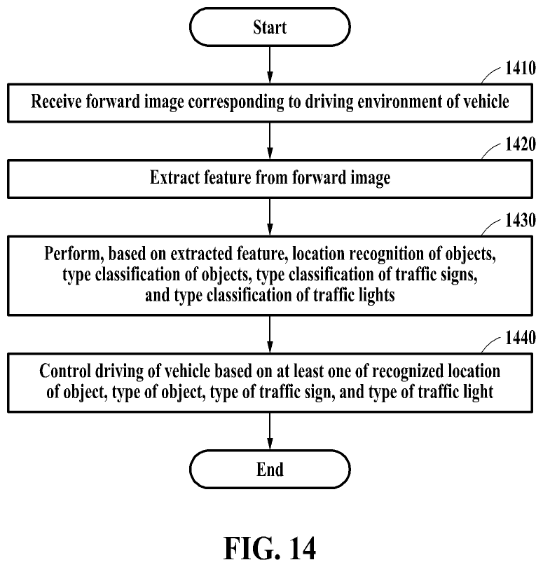

FIG. 14 illustrates an example operation in which an example electronic device controls a vehicle through object recognition.

The operations may be performed sequentially but not necessarily. For example, the order of the operations may be changed and at least two of the operations may be performed in parallel. Operations 1410 to 1440 may be performed by at least one component (e.g., one or more processors) of the electronic device.

In operation 1410, the electronic device may receive a forward image corresponding to the driving environment of a vehicle.

In operation 1420, the electronic device may extract a feature from the received forward image.

In operation 1430, the electronic device may perform, based on the extracted feature, the recognition of a location of objects, the type classification of objects, the type classification of traffic signs, and the type classification of traffic lights. For example, the electronic device may determine the types of traffic signs and/or traffic lights and the detailed types of traffic signs and/or traffic lights.

In operation 1440, the electronic device may control the driving of the vehicle based on at least one of the recognized location of the object, the type of object, the type of traffic sign, and the type of traffic light. For example, the electronic device may determine traffic information indicated by the object based on the detailed type of traffic sign to which the object corresponds. The electronic device may control a driving of the vehicle based on the traffic information. Additionally, the electronic device may determine signal information indicated by the object based on the detailed type of traffic light to which the object corresponds. The electronic device may control a driving of the vehicle based on the signal information. The electronic device may control the driving of the vehicle based on the determined traffic information and/or signal information. For example, the electronic device may control the driving speed, driving direction, and gear shifting of the vehicle.

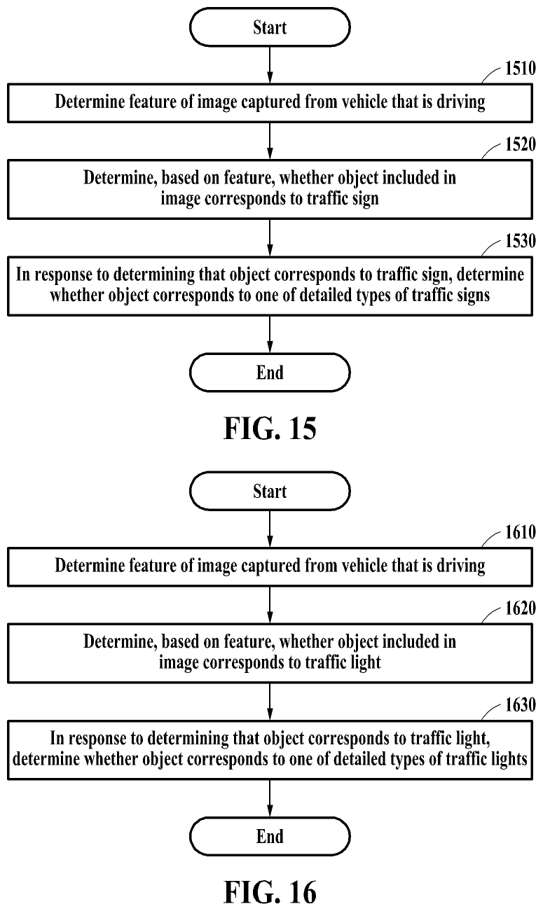

FIG. 15 illustrates an example operating method of an electronic device for a traffic sign.

The operations may be performed sequentially but not necessarily. For example, the order of the operations may be changed and at least two of the operations may be performed in parallel. Operations 1510 to 1530 may be performed by at least one component (e.g., one or more processors) of the electronic device.

In operation 1510, the electronic device may determine a feature of an image captured from a vehicle that is travelling.

In operation 1520, the electronic device may determine, based on the feature, whether an object of interest included in the image corresponds to a traffic sign. The electronic device may determine, based on the feature, first probabilities that the object of interest corresponds to each of the predetermined types of objects and may determine whether the object of interest corresponds to the traffic sign based on the first probabilities.

In operation 1530, in response to determining that the object of interest corresponds to the traffic sign, the electronic device may determine whether the object of interest corresponds to one of the detailed types of traffic signs. When it is determined that the object of interest corresponds to the traffic sign, the electronic device may determine, based on the feature, second probabilities that the object of interest corresponds to each of the detailed types of traffic signs and may determine, based on the second probabilities, which of the detailed types of traffic signs the object corresponds to. When it is determined that the object of interest corresponds to the traffic sign, the electronic device may determine, based on the feature, which of the intermediate detailed types of traffic signs the object of interest corresponds to and may repeatedly perform, by a predetermined number of layers, the determination of which of the intermediate detailed types of traffic signs the object of interest corresponds to, based on an intermediate detailed type of traffic sign to which the object of interest corresponds. The electronic device may determine the intermediate detailed types of traffic signs and the number of layers based on the feature.

The electronic device may determine traffic information indicated by the object of interest based on the detailed type of traffic sign to which the object corresponds and may control the vehicle based on the traffic information. The electronic device may recognize, based on the feature, a speed limit written on the object of interest when it is determined that the object of interest corresponds to a speed sign among the detailed types of traffic signs. When it is determined that the object of interest corresponds to a character sign among the detailed types of traffic signs, the electronic device may recognize the character written on the object of interest based on the feature.

When it is determined that the object of interest does not correspond to the traffic sign, the electronic device may determine whether the object of interest corresponds to the traffic light. In response to determining that the object of interest corresponds to the traffic light, the electronic device may determine whether the object of interest corresponds to one of the detailed types of traffic lights. When it is determined that the object of interest does not correspond to the traffic sign, the electronic device may determine which of the types of objects the object of interest corresponds to.

The detailed types of traffic signs may include at least one of a speed sign, a character sign, or a guidance sign, as only examples.

The descriptions provided with reference to FIGS. 1 to 14 may apply to the operations of FIG. 15, and thus, a further detailed description is omitted.

FIG. 16 illustrates an example operating method of an electronic device for a traffic light.

The operations may be performed sequentially but not necessarily. For example, the order of the operations may be changed and at least two of the operations may be performed in parallel. Operations 1610 to 1630 may be performed by at least one component (e.g., a processor) of the electronic device.

In operation 1610, the electronic device may determine a feature of an image captured from a vehicle that is travelling. The electronic device may determine, based on the feature, first probabilities that an object of interest corresponds to each of the predetermined types of objects and may determine whether the object of interest corresponds to the traffic light based on the first probabilities.

In operation 1620, the electronic device may determine, based on the feature, whether the object of interest included in the image corresponds to the traffic light feature. When it is determined that the object of interest corresponds to the traffic light, the electronic device may determine, based on the feature, second probabilities that the object of interest corresponds to each of the detailed types of traffic lights and may determine, based on the second probabilities, which of the detailed types of traffic lights the object of interest corresponds to.

In operation 1630, in response to determining that the object of interest corresponds to the traffic light, the electronic device may determine whether the object of interest corresponds to one of the detailed types of traffic lights. When it is determined that the object of interest corresponds to the traffic light, the electronic device may determine, based on the feature, which of the intermediate detailed types of traffic lights the object of interest corresponds to and may repeatedly perform, by a predetermined number of layers, the determination of which of the intermediate detailed types of traffic lights the object of interest corresponds to, based on an intermediate detailed type to which the object of interest corresponds.

The electronic device may determine signal information indicated by the object of interest based on the detailed type of traffic light to which the object of interest corresponds and may control the vehicle based on the signal information.

The detailed types of traffic lights may be determined based on the number of signals of the traffic light and the signal type.

The descriptions provided with reference to FIGS. 1 to 14 may apply to the operations of FIG. 16, and thus, a further detailed description is omitted.

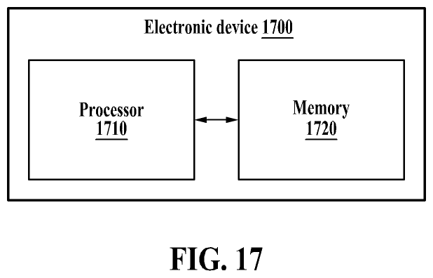

FIG. 17 illustrates an example electronic device, in accordance with one or more embodiments.

Referring to FIG. 17, an electronic device 1700 may include a processor, or one or more processors, 1710. The processor 1710 may include at least one processor. Additionally, the electronic device 1700 may further include a memory 1720.

The memory 1720 may store instructions (or programs) executable by the processor 1710. For example, the instructions may include instructions for executing an operation of the processor 1710 and/or an operation of each component of the processor 1710.

The processor 1710 may be a device that executes instructions or programs or controls the electronic device 1700 and may include, for example, various processors such as a central processing unit (CPU) and a GPU. The processor 1710 may determine a feature of an image captured from a vehicle that is travelling. The processor 1710 may determine, based on the feature, whether an object of interest included in the image corresponds to a traffic sign. In response to determining that the object of interest corresponds to the traffic sign, the processor 1710 may determine whether the object of interest corresponds to one of the detailed types of traffic signs.

The processor 1710 may determine, based on the feature, first probabilities that the object of interest corresponds to each of the predetermined types of objects and may determine whether the object of interest corresponds to the traffic sign based on the first probabilities. When it is determined that the object corresponds to the traffic sign, the processor 1710 may determine, based on the feature, second probabilities that the object of interest corresponds to each of the detailed types of traffic signs, and may determine, based on the second probabilities, which of the detailed types of traffic signs the object of interest corresponds to. The processor 1710 may determine traffic information indicated by the object of interest based on the detailed type of traffic sign to which the object of interest corresponds, and may control the vehicle based on the traffic information. When it is determined that the object of interest corresponds to a speed sign among the detailed types of traffic signs, the processor 1710 may recognize a speed limit written on the object of interest based on the feature. When it is determined that the object of interest corresponds to a character sign among the detailed types of traffic signs, the processor 1710 may recognize the character written on the object of interest based on the feature. When it is determined that the object of interest corresponds to the traffic sign, the processor 1710 may determine, based on the feature, which of the intermediate detailed types of traffic signs the object of interest corresponds to and may repeatedly perform, by a predetermined number of layers, the determination of which of the intermediate detailed types of traffic signs the object of interest corresponds to, based on an intermediate detailed type to which the object of interest corresponds. The processor 1710 may determine the intermediate detailed types and the number of layers based on the feature. When it is determined that the object of interest does not correspond to the traffic sign, the processor 1710 may determine whether the object of interest corresponds to the traffic light and may determine whether the object of interest corresponds to one of the detailed types of traffic lights in response to determining that the object of interest corresponds to the traffic light. When it is determined that the object of interest does not correspond to the traffic sign, the processor 1710 may determine which of the types of objects the object corresponds to.

The processor 1710 may determine the feature of the image captured from the vehicle that is travelling. The processor 1710 may determine, based on the feature, whether the object of interest included in the image corresponds to the traffic light. When it is determined that the object corresponds to the traffic light, the processor 1710 may determine whether the object of interest corresponds to one of the detailed types of traffic lights.

When it is determined that the object of interest corresponds to the traffic light, the processor 1710 may determine, based on the feature, second probabilities that the object corresponds to each of the detailed types of traffic lights and may determine, based on the second probabilities, which of the detailed types of traffic lights the object corresponds to. The processor 1710 may determine signal information indicated by the object of interest according to the detailed type of traffic light to which the object corresponds and may control the vehicle based on the signal information. When it is determined that the object of interest corresponds to the traffic light, the processor 1710 may determine, based on the feature, which of the intermediate detailed types of traffic lights the object of interest corresponds to and may repeatedly perform, by a predetermined number of layers, the determination of which of the intermediate detailed types of traffic lights the object of interest corresponds to, based on an intermediate detailed type to which the object of interest corresponds.

In addition, the electronic device 1700 may process the operations described above.

The processors, memories, image sensors, communication modules, buses, image sensors, input/output hardware, and dataset and database storage media described herein, including descriptions with respect to respect to FIGS. 1-17, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-17 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
one or more processors; and
a memory storing instructions,
wherein the instructions, when executed by the one or more processors, cause the electronic device to:
determine a feature of an image captured from a vehicle;
determine, based on the determined feature, whether objects comprised in the image correspond to traffic signs; and
determine, in response to determining that the objects correspond to the traffic signs, whether the objects correspond to one of detailed types of the traffic signs.

2. The electronic device of claim 1, wherein the instructions, when executed by the one or more processors, cause the electronic device to:
determine, based on the feature, first probabilities that the objects correspond to each of predetermined types of the objects; and
determine whether the objects correspond to the traffic signs based on the determined first probabilities.

3. The electronic device of claim 1, wherein the instructions, when executed by the one or more processors, cause the electronic device to:
determine, based on the feature, second probabilities that the objects correspond to each of the detailed types of the traffic signs, in response to determining that the objects correspond to the traffic signs; and
determine, based on the determined second probabilities, which of the detailed types of the traffic signs the objects correspond to.

4. The electronic device of claim 1, wherein the detailed types of the traffic signs comprise at least one of a speed sign, a character sign, and a guidance sign.

5. The electronic device of claim 3, wherein the instructions, when executed by the one or more processors, cause the electronic device to:
determine traffic information indicated by the objects based on the detailed types of the traffic signs to which the objects correspond; and
control the vehicle based on the determined traffic information.

6. The electronic device of claim 3, wherein the instructions, when executed by the one or more processors, cause the electronic device to detect a speed limit written on the objects based on the feature, in response to determining that the objects correspond to a speed sign among the detailed types of the traffic signs.

7. The electronic device of claim 3, wherein the instructions, when executed by the one or more processors, cause the electronic device to detect a character written on the objects based on the feature, in response to determining that the objects correspond to a character sign among the detailed types of the traffic signs.

8. The electronic device of claim 1, wherein the instructions, when executed by the one or more processors, cause the electronic device to:
determine, based on the feature, which of intermediate detailed types of the traffic signs the objects correspond to, in response to determining that the objects correspond to the traffic signs; and
repeatedly perform, by a predetermined number of layers, the determination of which of the intermediate detailed types of the traffic signs the objects correspond to, based on an intermediate detailed type of traffic sign to which the objects correspond.

9. The electronic device of claim 8, wherein the instructions, when executed by the one or more processors, cause the electronic device to determine, based on the feature, the intermediate detailed types of the traffic signs and the predetermined number of the layers.

10. The electronic device of claim 1, wherein the instructions, when executed by the one or more processors, cause the electronic device to:
determine whether the objects correspond to traffic lights, based on a determination that the objects do not correspond to the traffic signs; and
determine whether the objects correspond to one of detailed types of the traffic lights, in response to determining that the objects correspond to the traffic lights.

11. The electronic device of claim 1, wherein the instructions, when executed by the one or more processors, cause the electronic device to determine which of other types of the objects the objects comprised in the image correspond to, in response to determining that the objects do not correspond to the traffic signs.

12. An electronic device, comprising:
one or more processors; and
a memory storing instructions,
wherein the instructions, when executed by the one or more processors, cause the electronic device to:
determine a feature of an image captured from a vehicle; and
determine, based on the determined feature, whether objects comprised in the image correspond to traffic lights; and
determine, in response to determining that the objects correspond to the traffic lights, whether the objects correspond to one of detailed types of the traffic lights.

13. The electronic device of claim 12, wherein the instructions, when executed by the one or more processors, cause the electronic device to:
determine, based on the feature, second probabilities that the objects correspond to each of the detailed types of the traffic lights, in response to determining that the objects correspond to the traffic lights; and
determine, based on the determined second probabilities, which of the detailed types of the traffic lights the objects correspond to.

14. The electronic device of claim 12, wherein the detailed types of the traffic lights are determined according to a number of signals of the traffic lights and a signal type of the traffic lights.

15. The electronic device of claim 12, wherein the instructions, when executed by the one or more processors, cause the electronic device to:
determine signal information indicated by the objects based on the detailed types of the traffic lights to which the objects correspond; and
control the vehicle based on the determined signal information.

16. The electronic device of claim 12, wherein the instructions, when executed by the one or more processors, cause the electronic device to:
determine, based on the feature, which of intermediate detailed types of the traffic lights the objects correspond to, in response to determining that the objects correspond to the traffic lights; and
repeatedly perform, by a predetermined number of layers, the determination of which of the intermediate detailed types of the traffic lights the objects correspond to, based on an intermediate detailed type of the traffic lights to which the objects correspond.

17. A method, comprising:
determining a feature of an image captured from a vehicle;
determining, based on the determined feature, whether objects comprised in the image correspond to traffic signs; and
determining, in response to determining that the objects correspond to the traffic signs, whether the objects correspond to one of detailed types of the traffic signs.

18. The method of claim 17, wherein the determining of whether the objects correspond to the traffic signs comprises:
determining, based on the feature, first probabilities that the objects correspond to each of predetermined types of the objects; and
determining whether the objects correspond to the traffic signs based on the first probabilities.

19. The method of claim 17, wherein the determining of whether the objects correspond to one of the detailed types of the traffic signs comprises:
determining, based on the feature, second probabilities that the objects correspond to each of the detailed types of the traffic signs, in response to determining that the objects correspond to the traffic signs; and
determining, based on the determined second probabilities, which of the detailed types of the traffic signs the objects correspond to.

20. The method of claim 19, further comprising:
determining traffic information indicated by the objects based on the detailed types of the traffic signs to which the objects correspond; and
controlling the vehicle based on the determined traffic information.
